(19) United States
(12) Patent Application Publication
(10) Pub. No.: US 2016/0335799 A1
(43) Pub. Date: Nov. 17, 2016

(54) METHOD, SYSTEM AND COMPUTER PROGRAM PRODUCT FOR 3D OBJECTS GRAPHICAL REPRESENTATION

(71) Applicants: UNIVERSITE DE NICE, Nice (FR); CENTRE NATIONAL DE LA RECHERCHE SCIENTIFIQUE, Paris Cedex 16 (FR)

(72) Inventors: Marc ANTONINI, Nice (FR); Anis MEFTAH, Juan-les-Pins (FR); Leonardo HIDD FONTELES, Nice (FR); Frédéric PAYAN, Sophia-Antipolis (FR)

(21) Appl. No.: 15/110,068

(22) PCT Filed: Jan. 26, 2015
(86) PCT No.: PCT/EP2015/051511

§ 371 Date: Jul. 6, 2016

(30) Foreign Application Priority Data
Jan. 27, 2014 (EP) 14152728.3

(51) Int. Cl. G06T 17/20; G06T 15/00

(52) U.S. Cl. CPC G06T 17/205; G06T 15/005; G06T 2210/36

(57) ABSTRACT

A method and system for generating a three-dimensional (3D) multi-resolution meshing structure is provided. The 3D multi-resolution meshing structure is obtained in a two-steps simplification and refinement process that does not require a 3D-to-2D parameterization phase and wherein the geometry of the surface of the 3D object is used during the refinement step.

### TECHNICAL FIELD

The present invention relates to the field of multi-dimensional digital data processing and more particularly to a method, system and computer program product for 3D objects graphical representation.

### BACKGROUND ART

Thanks to the spectacular development of acquisition systems, more and more detailed 3D volume data are acquired. These 3D data have huge sizes which easily exceed many terabytes and can reach the petabyte. The graphical representation of the 3D surfaces is commonly handled as polygons meshes, and it becomes current to have meshing models with billions of polygons.

Various meshing techniques are described in the article of F. Payan and C. Roudet titled <<Remaillage semi-régulier pour les maillages surfaciques>> available in Revue Électronique Francophone d'Informatique Graphique, Volume 5, Numéro 1, pp. 27-40, 2011. As detailed in the article, the geometry of the meshes is dense and the connectivity of the meshes is arbitrary. This is a problem which requires remeshing the representation of the meshes to lower its complexity to obtain a more regular connectivity.

Many remeshing approaches have been proposed up to date. The semi-regular remeshing approach is one that is particularly adapted to the representation of a multi-resolution mesh. Generally speaking, on a first step, a simplification operation is applied to an original input mesh to generate a base mesh. On a second step, a refinement operation is applied on the base mesh, commonly also denoted as coarse mesh, to obtain a semi-regular mesh.

FIG. 1 is a general illustration of the remeshing process. An original mesh as shown on the left is first simplified to create a coarse mesh which is then refined to obtain a semi-regular mesh as shown on the right of the figure.

The simplification step, in known semi-regular remeshing processes, includes a parameterization operation that allows linking the original 3D surface of the object to its 2D representation.

However, the parameterization is a complex operation which prevents using it for high resolution meshing surfaces. And none of the known remeshing methods using parameterization is satisfactory for processing high resolution 3D objects, particularly for computer graphical representation.

Thus, there is the need for a solution to solve the aforementioned problems. The present invention offers such solution.

### SUMMARY OF THE INVENTION

An object of the invention is to provide a semi-regular remeshing method that does not require a 3D-to-2D parameterization phase.

Advantageously, the proposed method comprises a first step of simplifying the input mesh to create a base mesh, and a second iterative step of successively refining the base mesh to obtain the semi-regular mesh.

Advantageously, the geometry of the surface of the input mesh is used during the iterative refinement step.

Advantageously, the method is suitable for handling out-of-core meshing structure.

According to a first embodiment of the present invention, there is provided a method as further described in the appended independent claim 1.

Particularly, a computer implemented method of generating a three-dimensional (3D) multi-resolution meshing structure having ‘n’ levels of details (LOD) is described. The method comprises the steps of:

creating a base mesh from a 3D input mesh; and

iteratively refining the base mesh to match the surface of the 3D input mesh by:
applying a regular subdivision on a ith level of detail of the base mesh to obtain a (i+1)th level of detail; and
optimizing the (i+1)th level of details by applying a constrained vertex clustering method on the surface of the 3D input mesh.

The regular subdivision of the refinement step allows generating output vertices positioned at a mid-path cluster frontier over the 3D input mesh surface, and having the (i+1)th level of detail composed of the output vertices of the ith level of detail plus the output vertices issued from the regular subdivision of the ith level.

Further embodiments are described in the appended dependent claims.

According to yet another embodiment of the present invention there is provided an apparatus comprising means adapted for carrying out each step of the method according to the different embodiments of the invention.

There is also provided a computer readable medium having encoded thereon a computer program comprising instructions for carrying out the steps of the method of the invention when the computer program is executed on a computer.

Further advantages of the present invention will become clear to the skilled person upon examination of the drawings and detailed description. It is intended that any additional advantages be incorporated therein.

### DESCRIPTION OF THE DRAWINGS

Embodiments of the present invention will now be described by way of examples with reference to the accompanying drawings in which:

FIG. 1 shows an illustration of a semi-regular remeshing process;

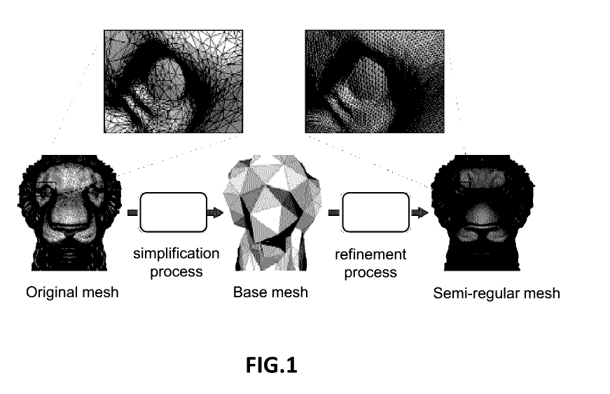

FIG. 2 is a general flow chart of the remeshing process of the present invention;

FIG. 3 shows a general flow chart of the three steps of the simplification process in a preferred embodiment of the present invention;

FIG. 4 details the seed optimization step of the simplification process of FIG. 3;

FIG. 5 shows a flow chart of the iterative refinement process in a preferred embodiment of the present invention;

FIG. 6 shows a flow chart of the seed optimization steps of the refinement process of FIG. 5;

FIG. 7 depicts a general computer environment to operate the present invention.

### DETAILED DESCRIPTION OF THE INVENTION

It is to be appreciated that the same elements are referenced by the same numerals in all figures.

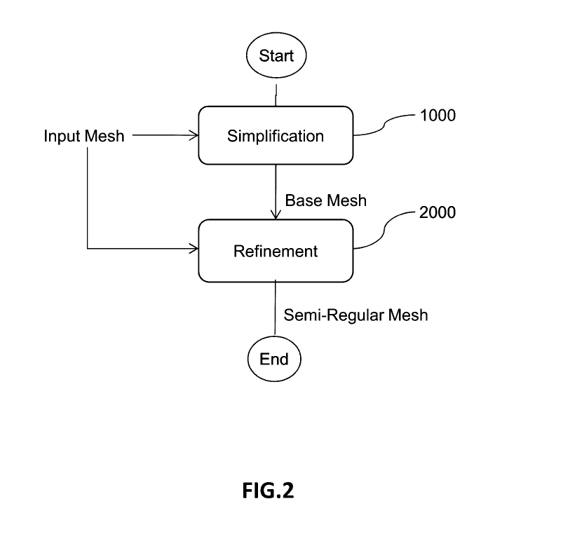

Going first to FIG. 2, a general flow chart of the remeshing process of the present invention is now described. Generally speaking, the remeshing process may be implemented as part of a computer as a first module (1000) for processing the simplification operation and a second module (2000) for processing the refinement operation of the present invention. The simplification module (1000) receives data representing an original mesh to be processed. The simplification module generates as output a base mesh. In a preferred embodiment, a simplification operation based upon vertex clustering constrained on the 3D input mesh surface is implemented.

Alternatively, other simplification algorithms can be used to generate the base mesh such as the well-known <<Valette>> from S. Valette and J. M. Chassery, <<Approximated Centroidal Voronoi Diagrams for Uniform Polygonal Mesh Coarsening>> in Computer Graphics Forum (Eurographics 2004 proceedings, vol. 23, no. 3, pp. 381-389, 2004), the <<Scopigno>> from P. Cignoni, C. Rocchini, C. Montani, R. Scopigno, <<External Memory Management and Simplification of Huge Meshes>> in IEEE Trans. on Visualization and Comp. Graph., Vol. 9, no. 4, pp. 525-537, 2003, the <<VSA>> from David Cohen-Steiner, Pierre Alliez, Mathieu Desbrun, <<Variational shape approximation>> in ACM Transactions on Graphics (TOG), vol. 23, no. 3, pp. 905-914, 2004 or the <<Q-slim>> from M. Garland and P. Heckbert <<Surface Simplification Using Quadric Error Metrics>> in Proceedings of SIGGRAPH 97.

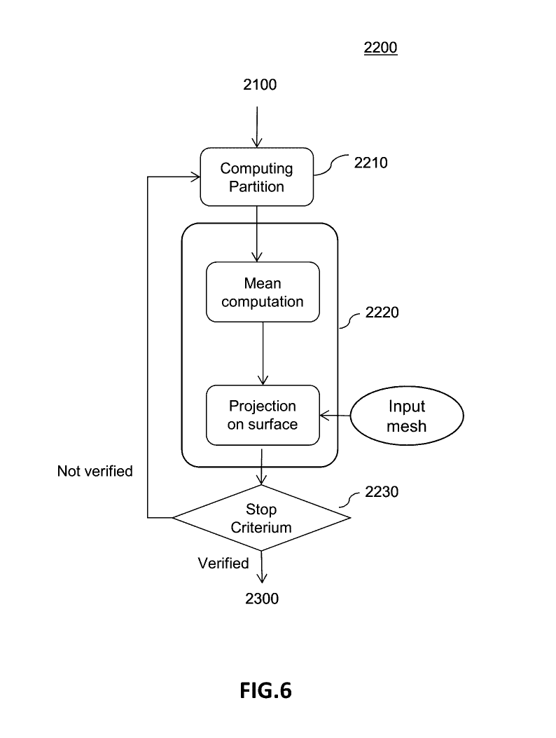

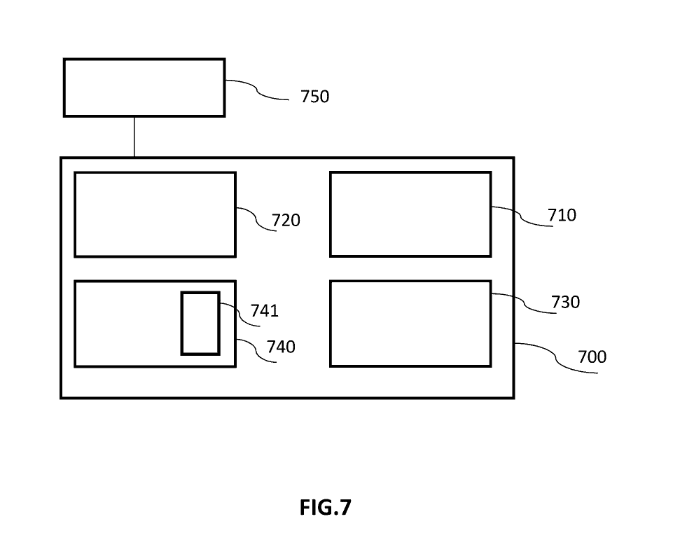

The base mesh data output from the simplification module are then input to a refinement module (2000) to produce a semi-regular mesh. The refinement module also receives as additional inputs the data representing the original mesh to execute the refinement operation according to the present invention and as it will be further detailed with reference to FIGS. 6 and 7.

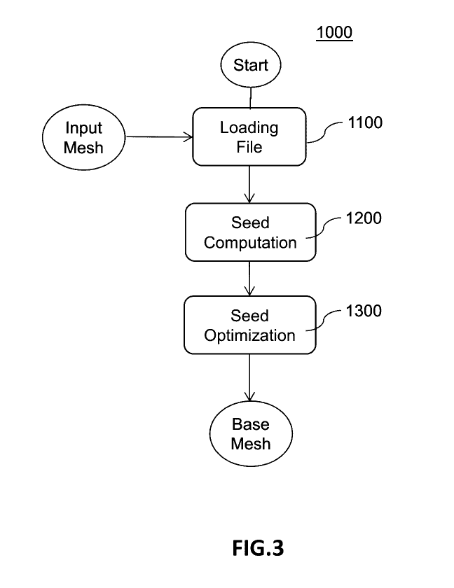

FIG. 3 shows in more details the steps executed by the simplification module (1000) of FIG. 2 in a preferred embodiment.

On a first step (1100), the data representing the input mesh are loaded into a computer memory. Next, a computation (1200) is done to determine an initial group of seeds, and an optimization operation (1300) is done to optimize the initial group of seeds. A base mesh is output.

As it is well known by a person skilled in the art, the seeds initialization (1200) depends on various constraints in order to preserve the main characteristics of the original mesh such as the geometry boundaries (holes), the texture boundaries, the sharp features, the genus or the input mesh density among others characteristics.

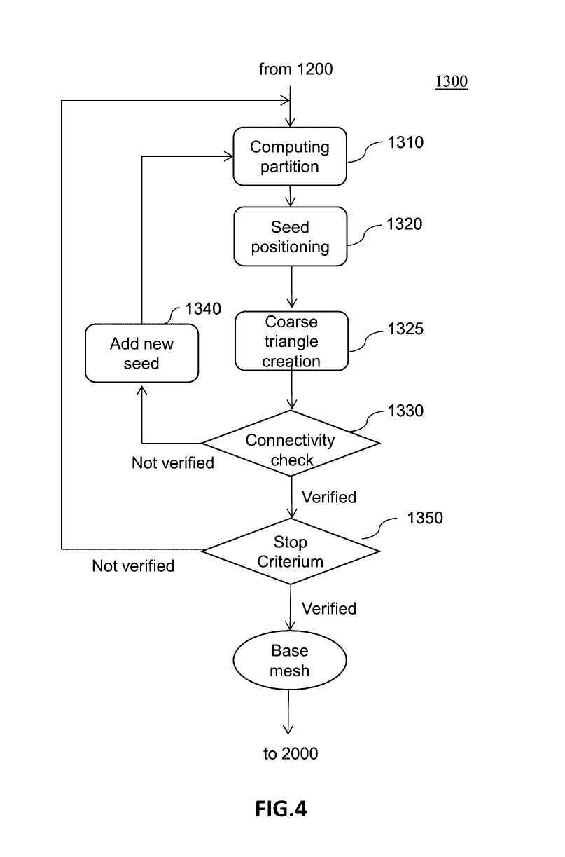

FIG. 4 shows in more details the seed optimization step (1300) of FIG. 3.

In a first step (1310), the process allows computing the seeds partitioning (a partition is composed by clusters, each of them represented by one seed) for the initial group of seeds generated during the seed initialization step (1200). In a preferred embodiment, the geodesic distance d_{g}(s, ŝᵢ) (or any approximation) between two vertices under a constraint on the normal associated to the vertices, is minimized.

For ease of clarity and comprehension of the various equations, the following parameters represent:
‘s’: a vertex belonging to the original mesh;
‘Pᵢ’: a ith cluster of the partition;
‘ŝᵢ’: a seed of a ith cluster ‘Pᵢ’, i.e. a vertex belonging to the output semi-regular mesh ‘Sᵣ’;
‘nₛ’: a normal of the input mesh surface at vertex ‘s’;
‘n_{ŝi}’: a normal at vertex ‘ŝᵢ’;

Basically, all vertices belonging to the same cluster Pᵢ₋ i.e. which minimize the geodesic distance with respect to the seed of Pᵢ₋ should have the closest normals as possible.

This latter property may be mathematically expressed by the following equation (1):

Ø(s,ŝᵢ)=d_{g}(s,ŝᵢ)+λd(nₛ,n_{ŝ}_{ᵢ})∀ŝᵢεsᵣ (1)

In a preferred embodiment, the optimal partition for the entire mesh is obtained by minimizing the function of equation (1) for all vertices ‘s’ of the input mesh.

Going now to the next step (1320) of FIG. 4, the process allows computing the optimal positioning of the seeds inside each cluster Pᵢ.

To compute the optimal position of the seeds in each cluster, one can minimize the ‘L²’ distance d(s, ŝᵢ) constrained to the distance of all vertices ‘s’ belonging to the same cluster. This can be achieved by minimizing between two vertices the criterion of the following equation (2):

ψ(s,ŝᵢ)=d(s,ŝᵢ) (2)

In a preferred embodiment, the optimal solution is obtained by minimizing in the following function (3) where d(s,ŝᵢ) in (2) is expressed as the ‘L²’ distance and ρ(s)′ represents any density function evaluated at a given vertex ‘s’:

Ψ=E[d]=ΣᵢΣ_{sεP}_{ᵢ}∥s−ŝᵢ∥²ρ(s) (3)

The skilled man would appreciate that the solution of this minimization problem is given by the zero-order condition such as equation (4) below:

$$\frac{δ Ψ}{δ {\hat{s}}_{i}} = 0 \qquad ( 4 )$$

which admits a closed-form solution given by equation (5):

$${\tilde{s}}_{i} = \frac{{\sum }_{s ∈ {P}_{i}} s ρ ( s )}{{\sum }_{s ∈ {P}_{i}} ρ ( s )} \qquad ( 5 )$$

Next, \tilde{s}ᵢ is projected onto the surface of the input mesh for the next iteration. The projection may be done by positioning \tilde{s}ᵢ at the closest vertex ‘s’ in cluster ‘Pᵢ’.

On a next step (1325), the process allows creating coarse triangles and triangles connectivity between the coarse triangles.

Next step (1330) allows verifying the correctness of the coarse triangle connectivity, by checking if the seeds of the base mesh respect a plurality of criteria in order to validate the base mesh triangulation obtained at previous step.

If the base mesh does not verify the criteria (branch Not verified), new seeds are added (step 1340) and the process loops back to the computation of new clusters (step 1310).

In a preferred embodiment the connectivity criteria to be checked and the conditions for inclusion of new seeds are listed below:

a cluster Pᵢ that contacts a surface boundary must have its seed on that boundary. If this condition fails, a new seed is added on the boundary of the surface within cluster Pᵢ;

a cluster Pᵢ must have a zero genus. If this condition fails, a new seed is added at a vertex adjacent to the seed vertex of cluster Pᵢ;

the boundary of a cluster Pᵢ can only consist in a single connected component. If this condition fails, a new seed is added at a vertex adjacent to the seed vertex of the cluster Pᵢ;

a cluster Pᵢ that is adjacent to another cluster Pⱼ should not have more than one neighbor along each cluster boundary curve. If this condition fails, a new seed is added at a vertex adjacent to the cluster boundary curve;

any pair of cluster Pᵢ cannot touch along more than a single tile boundary curve. If this condition fails, a new seed is added at a vertex adjacent to the shorter among the offending cluster boundary curves.

The person skilled in the art would alternatively define others criteria.

Going back to step 1330 when all criteria are verified (branch Verified), meaning the coarse triangle connectivity is satisfactory, the process continues to step (1350) to check a stop criterion in order to terminate the seed optimization process. In a preferred embodiment, the stop criterion consists in checking the condition of the following equation (6):

$$\frac{( {Φ}^{k - 1} - {Φ}^{k} )}{{Φ}^{k - 1}} < ɛ \qquad ( 6 )$$

where ‘ε’ is a threshold defined by the user, with a clustering error at an iteration ‘k’ being defined by equation (7):

$${Φ}^{k} = {\sum }_{i} {\sum }_{s ∈ {P}_{i}} Φ ( s , {\hat{s}}_{i} ) \qquad ( 7 )$$

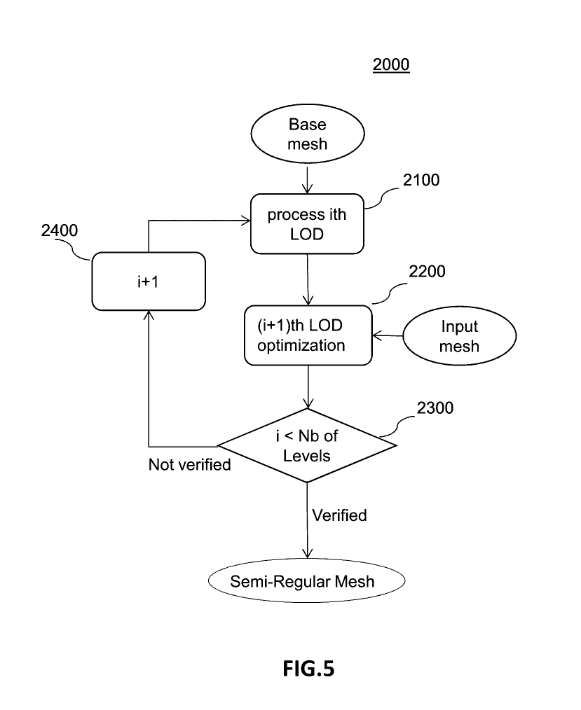

After termination of the simplification process providing a base mesh, the process enters the refinement process. FIG. 5 shows the main steps executed by the refinement module (2000) of the present invention. Once the base mesh is created, the process allows entering an iterative process as further described.

Generally speaking, the refinement process allows applying a regular subdivision on a ith Level Of Detail (LOD) to obtain a (i+1)th level of detail, thereby obtaining vertices positioned at the mid-path cluster frontier over the 3D input mesh surface. The (i+1)th level of detail is composed then of the output vertices of the ith level of detail plus the output vertices issued from the regular subdivision of the ith level.

Step 2100 allows setting the process at a (i+1)th level of detail by applying the regular subdivision as previously described, and next on step 2200 the process allows optimizing the (i+1)th level as further detailed with reference to FIG. 6.

Next step 2300 checks if all levels have been processed to provide the semi-regular mesh (branch Verified), otherwise the process loops back to step 2100 to apply a regular subdivision onto the next level (2400).

Going to FIG. 6, the steps of the optimization process of the refinement operation are now described.

On step 2210, the process allows computing clusters on the ith level of detail set on previous step 2100. In a preferred embodiment, the clusters are computed in a similar way as described for the partition computation of the simplification process in step 1310.

After the clusters computation, the process allows determining on step 2220 the optimal position of the seeds in each cluster. To achieve in a preferred embodiment, one can minimize the L² distance d(s, ŝᵢ) under a constraint, preserving the regularity of the input mesh.

This can be written as minimizing between two vertices the following criterion (8):

$$ψ ( s , {\hat{s}}_{i} ) = d ( s , {\hat{s}}_{i} ) + μ {\sum }_{j ∈ {V}_{{\hat{s}}_{i}}} {α}_{j} d ( {\hat{s}}_{j} , {\hat{s}}_{i} ) \qquad ( 8 )$$

where ‘V_{ŝi}’ defines the (One-ring neighborhood) of ŝᵢ in Sᵣ, i.e. all vertices of Sᵣ connected to ŝᵢ. The weights αⱼ are preferably chosen to limit the displacement of ŝᵢ during the optimization phase.

The optimal solution is obtained by minimizing the following function (9):

$$\begin{matrix}Ψ = E [ d ] + μ {\sum }_{i} {\sum }_{j ∈ {V}_{{\hat{s}}_{i}}} {α}_{j} d ( {\hat{s}}_{j} , {\hat{s}}_{i} ) \\ = {\sum }_{i} {\sum }_{s ∈ {P}_{i}} {‖ s - {\hat{s}}_{i} ‖}^{2} ρ ( s ) + μ {\sum }_{i} {\sum }_{j ∈ {V}_{{\hat{s}}_{i}}} {α}_{j} {‖ {\hat{s}}_{j} - {\hat{s}}_{i} ‖}^{2}\end{matrix}$$

The solution of this minimization problem is given by the zero-order condition given by equation (4):

$$\frac{δ Ψ}{δ {\hat{s}}_{i}} = 0$$

which admits a closed-form solution given by equation (10):

$${\tilde{s}}_{i} = \frac{{\sum }_{s ∈ {P}_{i}} s ρ ( s ) + μ {\sum }_{j ∈ {V}_{{\hat{s}}_{i}}} {α}_{j} {\tilde{s}}_{j}}{{\sum }_{s ∈ {P}_{i}} ρ ( s ) + μ {\sum }_{j ∈ {V}_{{\hat{s}}_{i}}} {α}_{j}} \qquad ( 10 )$$

Once the mean is computed, \tilde{S}ᵢ is projected to Ŝᵢ onto the surface of the input mesh for the next iteration. As an example, the projection can be done by computing the closest vertex ‘s’ to \tilde{S}₁ in cluster ‘Pᵢ’.

On a final step 2230, the process allows checking a stop criterion to end the optimization phase (branch Verified) and processing a further level if any (2300), otherwise (branch Not verified) the process loops back to step 2210 to compute a new partition for the current processed level.

FIG. 7 shows an example of computer device 700 for operating an embodiment of the present invention. The computer device may be a general purpose computer or personal computer having a central unit (710) and a computer screen (not depicted). The computer device further includes a hard disk drive (HDD) (720) with a limited available storage capacity of 250 gigabytes (Gb) for example as being a common capacity. The computer device (700) also includes a random access memory (RAM) (730) having its own capacity storage for example of 2 Gb. The computer device also includes a graphic card (740), having a video random access memory (VRAM) (741) which capacity is for example 512 megabytes (Mb). A scanning device (750) may be coupled to the hard disk drive of the computer device (700). The scanning device may be used to acquire 3D data which are stored on the hard disk drive. The hard disk drive stores a huge volume of 3D data to describe the original object. In operation, the central unit (710) allows loading a 3D object to be processed from the hard disk drive (720) into the RAM (730). The central unit (710) allows loading the data from the RAM (730) into the VRAM (741). The graphic card (740) allows computing the final rendering and sending it for display on the computer screen. The computer device includes one or more application programs. The application programs may include a simplification application program to operate the simplification process of the present invention and a refinement application program to operate the refinement process of the present invention. Finally, it is to be appreciated that the invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

1. A computer implemented method of generating a three-dimensional (3D) multi-resolution meshing structure having ‘n’ levels of details, the method comprising the steps of:
creating a base mesh from a 3D input mesh; and
iteratively refining the base mesh to match the surface of the 3D input mesh by:
applying a regular subdivision on a ith level of detail of the base mesh to obtain a (i+1)th level of detail; and
optimizing the (i+1)th level of detail by applying a constrained vertex clustering method on the surface of the 3D input mesh.

2. The method of claim 1 wherein the regular subdivision generates output vertices positioned at a mid-path cluster frontier over the 3D input mesh surface, and wherein the (i+1)th level of detail is composed of the output vertices of the ith level of detail plus the output vertices issued from the regular subdivision of the ith level.

3. The method of claim 1 wherein the 3D input mesh is a 3D mono-resolution mesh and the base mesh is created by applying a constrained vertex clustering method on the surface of a 3D input mesh.

4. The method of claim 1 wherein the step of creating the base mesh consists in applying one of a “Valette”, “Scopigno”, “VSA” or “Q-slim” algorithm.

5. The method of claim 1 wherein the step of creating the base mesh further comprising the steps of determining an initial group of seeds and applying an optimization algorithm to the initial group of seeds to generate the base mesh.

6. The method of claim 5 wherein the optimization algorithm comprises the steps of:
computing seeds partitions for the initial group of seeds;
computing the optimal positioning of the seeds inside each partition;
checking if the connectivity of the seeds of the base mesh verify a plurality of criteria; and
verifying a stop criterion.

7. The method of claim 6 wherein the connectivity checking comprises checking one or more of: checking if a cluster that contacts a surface boundary has its seed on that boundary, checking if a cluster has a zero genus, checking if the boundary of a cluster consists in a single connected component, checking if a cluster adjacent to another has more than one neighbor along each cluster boundary curve, checking if any pair of cluster does not touch along more than a single tile boundary curve.

8. The method of claim 1 wherein the step of optimizing the (i+1)th level of detail during the refining step further comprises computing clusters on the ith level of detail and determining the optimal position of the seeds in each cluster.

9. The method of claim 8 wherein the optimal position of the seeds in each partition is computed by minimizing the L² distance d(s, ŝᵢ) under a constraint preserving the regularity of the semi-regular output mesh.

10. The method of claim 1 further comprising a step of receiving data representing the 3D input mesh.

11. A system for generating a three-dimensional multi-resolution meshing structure having ‘n’ levels of detail comprising means adapted for carrying out each step of the method according to claim 1.

12. A visualization device for visualizing 3D multi-resolution meshing structure having ‘n’ levels of detail generated by the system of claim 11.

13. A computer readable medium having encoded thereon a computer program comprising instructions for carrying out the steps of the method according to claim 1 when said computer program is executed on a computer.
